(19) United States
(12) Patent Application Publication
(10) Pub. No.: US 2025/0382838 A1
(43) Pub. Date: Dec. 18, 2025

(54) VEHICLE SENSITIVE TO TOUCH ON THE BODYWORK

(71) Applicant: FERRARI S.P.A., MODENA (IT)

(72) Inventors: Pasquale VITIELLO, Modena (IT); Eduardo SUAIDEN, Modena (IT)

(21) Appl. No.: 19/233,876

(22) Filed: Jun. 10, 2025

(30) Foreign Application Priority Data
Jun. 13, 2024 (IT) 102024000013534

(51) Int. Cl. E05F 15/75; E05F 15/73

(52) U.S. Cl. CPC E05F 15/75; E05F 2015/763; E05F 2015/767

(57) ABSTRACT

Method and vehicle presenting an actuation system sensitive to the direct touch between an external body and the bodywork; the actuation system having a sensing unit, which is shielded by the bodywork.

### CROSS-REFERENCE TO RELATED APPLICATIONS

This patent application claims priority from Italian patent application No. 102024000013534 filed on Jun. 13, 2024, the entire disclosure of which is incorporated herein by reference.

### TECHNICAL FIELD

The invention concerns a method of operating a vehicle by touching the bodywork. Furthermore, the invention relates to a vehicle comprising a touch-sensing actuation system on the bodywork.

### PRIOR ART

It is well known that a vehicle comprises an outer bodywork shaped to meet certain aerodynamic and aesthetic requirements. It is also known that a vehicle comprises a plurality of human-machine interface components made up of separate bodies and assembled with the bodywork. They are commonly used human-machine interface components, for instance: handles, levers, buttons, optical sensors, etc.

Known human-machine interface components are used to operate respective vehicle drives, for instance: side doors, engine hood, trunk, fuel tank flap, electric charging flap, etc.

Known human-machine interface components represent design constraints and have the disadvantage of having to be assembled with the body. This necessarily implies the presence of joints, seats and/or coupling elements. Therefore, disadvantageously, known human-machine interface components interfere with the profile, affecting both the body aerodynamic performance and aesthetics.

### DESCRIPTION OF THE INVENTION

The object of the present invention is to provide a solution allowing to eliminate human-machine interface components assembled with the bodywork.

According to the present invention, a method is provided for operating a vehicle by a direct touch on the bodywork, as mentioned in the appended claims.

According to the present invention, a vehicle is provided comprising an actuation system as mentioned in the appended claims.

The dependent claims define particular embodiments of the invention.

### BRIEF DESCRIPTION OF THE DRAWINGS

Hereinafter, embodiments of the invention are described for a better understanding of the invention by way of non-limiting examples and with reference to the accompanying drawings, in which:

FIG. 1 is a schematic view, with some parts removed for clarity, of a vehicle according to the present invention;

FIG. 2 illustrates a detail of FIG. 1;

FIG. 3 is a schematic and plan view of a vehicle according to the present invention; and,

FIG. 4 is a schematic and plan view of a further embodiment of a vehicle according to the present invention.

### EMBODIMENTS OF THE INVENTION

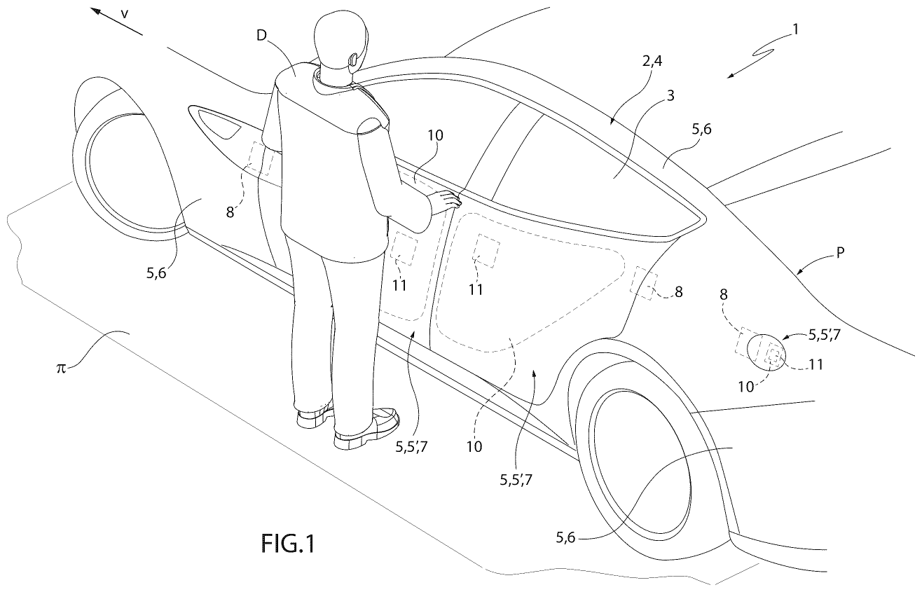

In FIG. 1, the reference number 1 is used to indicate, as a whole, a vehicle comprising, in a known and schematically illustrated manner: a supporting structure 2 (e.g., a body and/or chassis), which defines a passenger compartment 3 configured to accommodate at least one driver D and possibly one or more passengers (not illustrated); and a bodywork 4, which constitutes the outer covering of the supporting structure 2. The bodywork 4 is secured, in a known and non-illustrated manner, to the supporting structure 2. The vehicle 1 is roto-translating, in a known manner, on a horizontal support plane I. The terms ‘front’, ‘rear’, ‘right’, ‘left’, ‘upper’, ‘lower’ and the like are used with reference to the vehicle 1 moving forward on the support plane I in the forward direction v. The terms ‘outer’, ‘inner’ and the like are used with reference to the passenger compartment in which the driver D of vehicle 1 is seated while driving.

In a known manner, the bodywork 4 comprises, in turn, a plurality of outer panels 5 suitably shaped to form the aerodynamic profile P (stylised in FIG. 1) and, as a whole, the aesthetic appearance of the vehicle 1.

The shape and size of each panel 5 are variable. Panels 5 can be made of any material. By way of example, but not of limitation, panels 5 may be made of: composite material (e.g., carbon fibre); and/or metallic material; and/or crystal/glass; and/or polymeric material.

The term panel 5 refers to a body that covers a portion of the supporting structure 2. Panel 5 can be a laminar body. Panel 5 can be a thin body having a reduced thickness relative to its width and/or height.

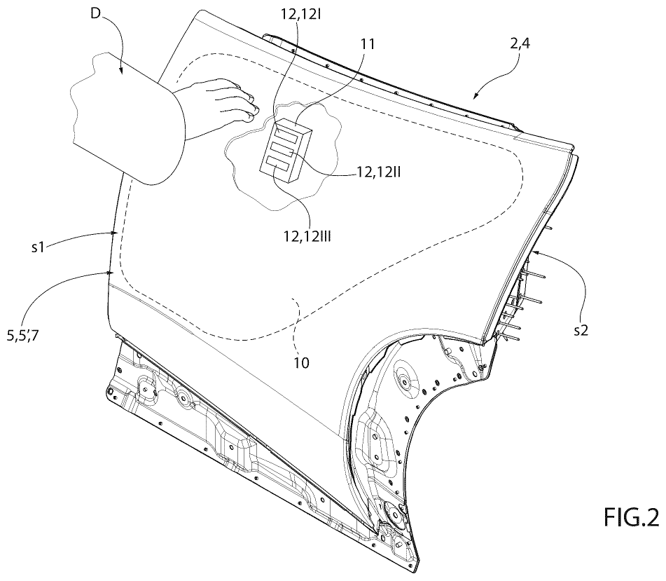

Panel 5 has an outer surface s1 and an inner surface s2 (FIG. 2).

The outer surface s1 faces the outside of the vehicle 1 and is shaped to form (generally, in combination with other panels 5), the aerodynamic and aesthetic profile P of the vehicle 1. The outer surface s1 can be coated and/or painted.

The inner surface s2 faces the supporting structure 2. The internal surface s2 is configured to facilitate the attachment of the panel 5 to the supporting structure 2 and the housing of any internal components of the vehicle 1.

The panels 5 of the bodywork 4 can be divided into fixed panels 6 and movable panels 7.

The fixed panels 6 are rigidly secured to the supporting structure 2. The fixed panels 6 can be of various types and shapes. For example, a fixed panel 6 can be used to form: a nose, a tail, a fender, a spoiler, a side skirt, a roof, etc.

Mobile panels 7 have one or more degrees of freedom with respect to the supporting structure 2. For example, a movable panel 7 can translate and/or rotate and/or rotate-translate with respect to the supporting structure 2. The movable panels 7 can be of various types and shapes. For example, a movable panel 7 can be used to form: a door, an engine hood, a trunk, a fuel tank flap, an electric charging flap, a sunroof, etc.

As known and schematically illustrated, the vehicle 1 comprises one or more actuating devices 8 interposed between the supporting structure 2 and respective movable panels 7. The actuating devices 8 are configured to move the respective movable panels 7 selectively and according to determined kinematics.

Advantageously, the actuating devices 8 move the respective movable panels 7 automatically (in other words, without requiring the direct intervention of the driver D). The actuating devices 8 can be chosen from a group of actuating devices 8 that differ from each other in terms of configuration and kinematics. For example, the actuating devices 8 can be configured to: open/close a door; open/close the engine hood; open/close the trunk; open/close the fuel tank flap; open/close the electric charging flap; open/close the sunroof; etc.

In addition, the vehicle 1 comprises an actuation system 15 which is configured, as will be explained in more detail below, to selectively control each actuating device 8 in function of any touch or gesture detected on the bodywork 4.

‘Touch’ means the direct contact between an external body and the bodywork 1. ‘Gesture’ means a determined sequence of contacts within a given time interval between an external body and the bodywork. The contacts that make up the gesture may differ from one another in: intensity and/or duration and/or nature, as will be better explained below. External body means either an animate body (a person or an animal) or an inanimate body (object). Hereinbelow, the driver D will be referred to as an external body and the direct contact on the bodywork is performed by the tapping and/or pressing and/or rubbing performed, for example, by the fingers of a hand.

The actuation system 15 comprises a control unit 9 and one or more sensing units 11, each of which is configured to emit signals in function of a possible touch or gesture on the bodywork 4, as will be explained better below.

Advantageously, the bodywork 4 screens the sensing unit 11, which is not visible, from outside the vehicle 1. In other words, the sensing unit 11 is placed inside the bodywork 4. The bodywork 4 is interposed between an external body and the sensing unit 11.

According to the embodiment illustrated in FIGS. 1 to 3, the actuation system 15 comprises a plurality of sensing units 11.

As illustrated in FIG. 2, a sensing unit 11 is attached to a respective panel 5 to form a sensorized panel 5′ of the bodywork 4.

A sensing unit 11 can be attached to the respective panel 5. According to the example shown in FIG. 2, the sensing unit 11 is installed between the respective panel 5 and the supporting structure 2. Alternatively or additionally, a sensing unit 11 can be incorporated within the respective panel 5 (e.g., in case of a panel 5 made of composite material) forming a single cohesive body.

Advantageously, the interaction between the driver D (or any other external body) and the sensing unit 11 takes place via the panel 5.

FIG. 2 shows a door, however, without loss of generality, a sensorized panel 5′ can be any type of panel 5 (any fixed panel 6 or a different type of movable panel 7).

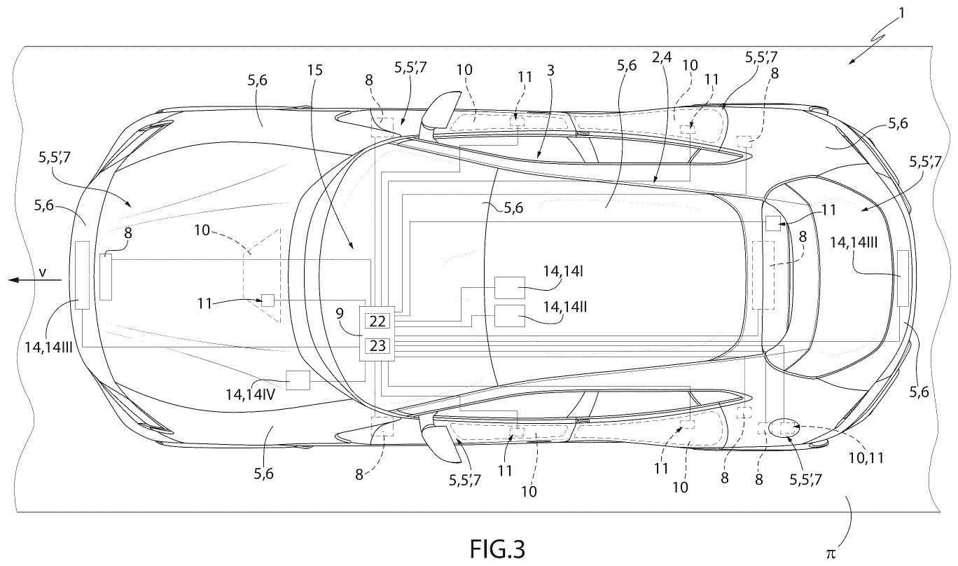

According to the example shown in FIG. 3, the vehicle 1 comprises a plurality of sensorized panels 5′: the engine hood, side doors, fuel tank flap and trunk are sensorized panels 5′.

Advantageously, a sensorized panel 5′ features a human-machine interface area 10. The interface area 10 is the area configured to best transmit physical phenomena (e.g., pressures or vibrations) generated by a touch or gesture to the respective sensing unit 11. Without loss of generality, the shape and size of an interface area 10 are variable. An interface area 10 can correspond to the whole outer surface s1 of the respective sensorized panel 5′.

Advantageously, in a sensorized panel 5′ the sensing unit 11 is capable of achieving, in particular at the interface area 10, the maximum resolution and ability to identify physical parameters related to the touch or gesture (such as position, nature, and intensity of each contact).

The shape and size of a sensing unit 11 are variable. A sensing unit 11 may comprise one or more sensors to detect parameters related to the touch or gesture, hereinbelow identified as touch sensors 12.

The sensing units 11 of the same vehicle 1 may differ from each other in: type of touch sensors 12 installed; size; and mutual arrangement of the respective touch sensors 12 (e.g., multiple sensing units 11 may differ from one another depending on the respective type of panel 5 to which they are attached).

The touch sensors 12 can be chosen from a group of sensors differing one from the other in type.

Advantageously, the sensing unit 11 comprises one or more contact sensors 121 configured to emit signals in function of pressures generated by a contact on the bodywork 4, in particular the respective panel 5.

Advantageously, the sensing unit 11 comprises one or more acoustic sensors 12II configured to emit signals in function of acoustic waves generated by a direct contact on the bodywork 4, in particular the respective panel 5.

Advantageously, the sensing unit 11 comprises one or more accelerometers 12III configured to emit signals in function of vibrations generated by the direct contact on the bodywork 4, in particular the respective panel 5.

Preferably, the contact sensors 12I and the acoustic sensors 12II of the sensing unit 11 can be chosen from a group of sensors of different types. For example, the contact sensors 12I and/or the acoustic 12II can be: piezoelectric sensors, e.g., of the type generally known as piezoelectric microelectromechanical system (piezoMEMS); or capacitive sensors.

Each sensing unit 11 exchanges the signals generated by the respective touch sensors 12 (121, 12II, 12III) with the control unit 9. The sensing unit 11 is capable of exchanging signals/data with the control unit 9 through a wired connection (FIG. 3) and/or a wireless connection (not shown).

Advantageously, the actuation system 15 further comprises a plurality of sensors configured to emit signals depending on the environmental conditions inside and/or outside the vehicle 1, hereinafter referred to as environmental sensors 14.

The environmental sensors 14 can be chosen from a group of sensors differing one from the other in type. The environmental sensors 14 may comprise: a microphone 14I configured to emit signals in function of environmental noises inside and/or outside the vehicle 1; and/or a camera 14II configured to emit signals related to images taken inside and/or outside the vehicle 1; and/or a radar 14III configured to emit signals in function of any external bodies; and/or a wireless receiver/emitter 14IV configured for proximity detection of external authentication elements (e.g., key/mobile device/smartphone). The environmental sensors 14 can exchange signals/data with the control unit 9 through a wired and/or wireless connection. Environmental sensors 14 can be placed in any position (outside or inside) of the vehicle 1.

The control unit 9 comprises, in turn, a memory unit 22 and a calculation unit 23. The memory unit 22 is configured to contain association data between input parameters and operating parameters for the selective operation of actuating devices 8. For example, a plurality of tables relating input parameters and operating parameters are stored into a memory unit 22. The calculation unit 23 is configured to select suitable association data. In particular, the control unit 9 is configured to classify the type of touch or gesture performed.

The input parameters can be divided into:
input parameters related to touch or gesture, obtained from the touch sensors 12; and
environmental input parameters, obtained from the environmental sensors 14.

The input parameters related to touch or gesture may comprise:
awakening event;
area of the bodywork 4 affected by contact;
intensity of the contact;
duration of the contact;
nature of the contact (tapping, rubbing, collision).

The environmental input parameters may comprise:
presence of the authentication elements;
ambient noise;
presence of external bodies.

The operating parameters may comprise one or more of the following parameters:
reporting of false positive events;
selection of each actuating device to be activated;
selection of the operating parameters of each actuating device to be activated;
selection of any additional drives (switching on interior lights/headlights/infotainment system or acoustic signals/warnings);
selection of any warnings or notes to be stored in the memory unit 22.

Advantageously, the driver D can customise the association data by setting one of his own gestures (a determined sequence within a given time interval of contacts, even different from each other in intensity and/or duration and/or nature) to activate a given actuating device 8.

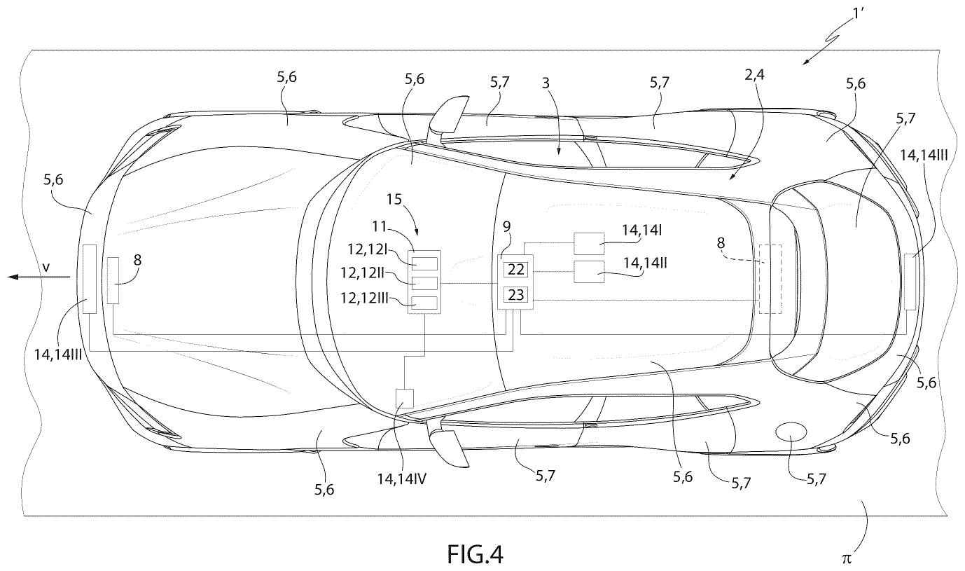

According to the further embodiment illustrated in FIG. 4, 1′ indicates a vehicle similar to the one shown in FIG. 1. Components in common with the embodiment described above retain the same numerals and are considered to be comprised therein without repeating them for the sake of brevity. The actuation system 15 of FIG. 4 comprises, unlike the solution illustrated in FIGS. 1 to 3, a single sensing unit 11 installed at any position within the vehicle 1′. In this case, the acoustic sensor 12II and the accelerometer 12III are configured to detect only the area in which acoustic waves and vibrations are emitted and, consequently, the area in which the contact occurred (front or rear area of the vehicle 1′).

Hereinbelow, a method of operating a vehicle 1 according to the present invention is described. Hereinbelow, in particular reference is made for brevity to a method in which a touch or gesture is performed on a sensorized panel 5′. Without loss of generality, the steps described hereinbelow can be performed mutatis mutandis with a plurality of sensorized panels 5′ and with any time sequence (even simultaneously).

In the case of a touch or gesture on a sensorized panel 5′ the respective sensing unit 11 generates and exchanges, with the control unit 9, signals that constitute the input parameters relating to the touch or gesture (awakening event and area, intensity, duration, and nature of each contact).

The environmental sensors 14 generate and exchange, with the control unit 9, signals that constitute the environmental input parameters (presence of authentication elements; noises inside/outside the vehicle 1; presence of external bodies). Advantageously, the absence of the authentication elements (e.g., a key/mobile device/smartphone/fingerprint scanner/face scanner) near vehicle 1 inhibits the activation of the actuating devices 8.

By correlating the input parameters relating to the touch or gesture and the environmental input parameters, the calculation unit 23 determines whether the touch or gesture is voluntary or whether the signals acquired are false positives.

If the calculation unit 23 determines that the touch or gesture is voluntary, the calculation unit 23 determines the type of actuating device 8 to be activated and the respective operating parameters. The calculation unit 23 can determine to emit any light and/or acoustic signals (warning or alarm). The calculation unit 23 may determine to store any warnings or notes (noting critical situations or activities, such as refuelling) in the memory 22 unit.

Advantageously, according to the embodiment illustrated in FIGS. 1 to 3, the fact of providing a plurality of sensorized panels 5′ makes the identification of the touch or gesture more precise and allows for a greater diversification of the actions that can be performed. For instance, it is possible to recognize and differentiate, on board a motor vehicle 1, the touches or gestures to open/close: a plurality of doors (right/left/front/rear); the engine hood; the trunk; the fuel tank flap and/or the electric charging flap; the sunroof, etc. Advantageously, a particular touch or gesture could furthermore be associated also with the execution of an additional drive connected for this purpose to the control unit 9. For example, the calculation unit 23 could associate a given touch or gesture with the control to switch on interior lights and/or headlights and/or the infotainment system, or the control to emit acoustic signals/warnings.

According to the embodiment illustrated in FIG. 4, in the vehicle 1′ there is only one sensing unit 11, which is located at any position inside the vehicle 1. According to this embodiment, it is possible to determine macro-areas of the vehicle 1′ (front or rear or side area) affected by the touch or gesture, in manners similar to those described above. However, in this case, the possibilities for diversification of the drives that can be activated are limited.

Advantageously, the solution according to the present invention allows a driver D to interact with the vehicle 1 through a direct contact with the bodywork 4. This allows known physical controls (pushbuttons, levers, etc.) to be replaced by gestures on the bodywork 4. Thus, advantageously, the profile P of a bodywork 4 of the type described above is free of gaps or protrusions at the areas of human-machine interaction 10. In other words, the bodywork 4 according to the present invention is free of physical human-machine interface components that break/protrude from the profile P of the bodywork 4. This makes it possible to produce vehicles 1 with a smooth and continuous profile P of the bodywork 4.

Advantageously, the bodywork 4 of the type described above has few, if any, joints, cuts, and/or seats. This simplifies the production process of the bodywork 4 itself and increases its strength, as possible areas of weakening are reduced, if not eliminated.

Advantageously, the bodywork 4 of the type described above increases the interaction between the driver D and the vehicle 1 through the direct contact with the bodywork 4, making the experience of the driver D more engaging.

Advantageously, the solution of the type described above allows for a high number of additional operations to be performed (switching on lights/headlights/infotainment display, emitting signals/acoustic warnings), even higher than those normally achievable using physical interface bodies.

Advantageously, the solution of the type described above allows for the customization of some controls, and this increases the safety factor of the vehicle 1 since only those who know a gesture, even customizable, can control certain operations (opening of the doors/fuel tank flap, etc.).

1. A method for the operation of a vehicle comprising a bodywork and an actuation system; wherein, the actuation system comprises: a sensing unit, which comprises a plurality of first sensors sensitive to physical phenomena generated by a direct touch between an external body and the bodywork; one or more actuating devices; and a control unit, which is configured to exchange signals and/or data with the sensing unit and each actuating device; wherein the bodywork shields the sensing unit; the method comprising the steps of:
generating, by means of said first sensors of the sensing unit, first signals in function of the direct touch between an external body and the bodywork;
exchanging said first signals between the sensing unit and the control unit; wherein, said first signals constitute first input parameters for the control unit; and
determining, by means of the control unit, the operation of one or more actuating devices in function of said input parameters;
wherein the actuation system comprises a plurality of second sensors, which are configured to generate second signals in function of the environmental conditions outside and/or inside the vehicle, the method comprising the steps of:
exchanging said second signals between the sensing unit and the control unit; wherein said second signals constitute said second input parameters for the control unit;
wherein the step of determining comprises to identify operating parameters associated with said first input parameters and said second input parameters.

2. The method according to claim 1, wherein said first input parameters comprise one or more of the following parameters:
detection of an awakening event;
area of the bodywork affected by each touch;
intensity of each touch;
duration of each touch;
nature of each touch.

3. The method according to claim 1, wherein said second input parameters comprise one or more of the following parameters:
presence of authentication elements;
environmental noises;
presence of external bodies.

4. The method according to claim 1, wherein the operating parameters comprise one or more of the following parameters:
report of false positive events;
selection of each actuating device to be activated;
selection of the operating parameters of each actuating device to be activated;
selection of any additional drives to be activated;
selection of any warnings or notes to be stored in the memory unit.

5. The method according to claim 1, wherein the vehicle comprises a supporting structure, on which said bodywork is installed; wherein the bodywork comprises, in turn, a movable panel; wherein an actuating device of the vehicle is configured to move said movable panel with respect to the supporting structure; wherein, the step of determining comprises to activate the actuating device so as to selectively move the movable panel with respect to the supporting structure.

6. The method according to claim 1, wherein the actuation system comprises a plurality of sensing units each of which is applied to a respective portion of said bodywork; wherein the step of generating comprises to generate said first signals by means of a plurality of sensing units; wherein the step of exchanging comprises to exchange said first signals between said plurality of sensing units and the control unit.

7. A vehicle comprising a bodywork and an actuation system; wherein, the actuation system comprises, in turn: a sensing unit configured to detect physical phenomena generated by a direct touch between an external body and the bodywork; one or more actuating devices; and, a control unit, which is configured to exchange signals and/or data with the sensing unit and each actuating device; wherein the bodywork shields the sensing unit; wherein the sensing unit comprises a plurality of first sensors configured to emit first signals in function of each direct touch between an external body and the bodywork; wherein the actuation system comprises a plurality of second sensors, which are configured to emit second signals in function of the environmental conditions outside and/or inside the vehicle.

8. The vehicle according to claim 7, wherein said first sensors comprise: a pressure sensor configured to emit signals in function of the pressure exerted by the touch on the bodywork, in particular said pressure sensor is of the piezoelectric or capacitive type; and/or an acoustic sensor configured to emit signals in function of acoustic waves generated by the touch on the bodywork, in particular said acoustic sensor is of the piezoelectric or capacitive type; and/or an accelerometer configured to emit signals in function of vibrations generated by the touch on the bodywork.

9. The vehicle according to claim 7, wherein said second sensors comprise: a microphone configured to emit signals in function of environmental noises inside and/or outside the vehicle; and/or a camera configured to emit signals related to images taken inside and/or outside the vehicle; and/or a radar configured to emit signals in function of any external bodies; and/or a wireless receiver/emitter configured for proximity detection of external authentication elements.

10. The vehicle according to claim 7 and comprising a supporting structure, on which said bodywork is installed; wherein the bodywork comprises, in turn, a movable panel; wherein an actuating device of the vehicle is configured to move selectively said movable panel with respect to the supporting structure.

11. The vehicle according to claim 7, wherein the actuation system comprises a plurality of sensing units each of which is applied to a respective portion of the bodywork.

12. The vehicle according to claim 7, wherein the control unit is configured to perform the method according to claim 1.
